(19) United States
(12) Patent Application Publication
(10) Pub. No.: US 2020/0232376 A1
(43) Pub. Date: Jul. 23, 2020

(54) Diffusion Surface Alloyed Metal Exhaust Component

(71) Applicant: Tenneco Automotive Operating Company Inc., Lake Forest, IL (US)

(72) Inventor: Guangchun QUAN, Ann Arbor, MI (US)

(21) Appl. No.: 16/250,352

(22) Filed: Jan. 17, 2019

(51) Int. Cl. F01N 13/16; F01N 13/08; F01N 13/18; C23C 10/04; C23C 10/32; B32B 15/01; C22C 38/18; F01N 3/021; F01N 3/24

(52) U.S. Cl. CPC F01N 13/16; F01N 13/08; F01N 13/1888; C23C 10/04; C23C 10/32; F01N 2530/26; C22C 38/18; F01N 3/0211; F01N 3/24; F01N 2530/04; B32B 15/011

(57) ABSTRACT

An exhaust component for a motor vehicle with improved corrosion resistance, including an internal volume, an inlet for receiving exhaust gas, and an outlet for expelling exhaust gas. The exhaust component includes at least one wall that is made of a diffusion surface alloyed metal sheet. The diffusion surface alloyed metal sheet comprises a secondary metal that is formed to a primary metal substrate by diffusion. The primary metal substrate of the diffusion surface alloyed metal sheet is a stainless steel containing at least 10 percent chromium. The secondary metal of the diffusion surface alloyed metal sheet is a metal alloy containing 20 to 35 percent chromium. As a result, the secondary metal of the diffusion surface alloyed metal sheet provides improved corrosion resistance to salt spray and urea.

### FIELD

The present disclosure relates generally to exhaust components for motor vehicles and more particularly to exhaust components made of diffusion surface alloyed sheet metals.

### BACKGROUND

The statements in this section merely provide background information related to the present disclosure and may not constitute prior art.

Motor vehicles typically have an exhaust system that transports hot exhaust gases from an internal combustion engine powering the motor vehicle to the outside environment. Such exhaust systems are typically comprised of various exhaust components, including without limitation, headers, down pipes, x-pipes, exhaust pipes, and mufflers. Depending on the type of fuel source used to power the internal combustion engine in the motor vehicle (e.g., gasoline versus diesel), the exhaust system may include additional exhaust components that provide emissions control, including without limitation, catalytic converters, urea injectors, selective catalytic reduction (SCR) units, diesel oxidation catalysts (DOC), and diesel particulate filters (DPF). Traditionally, these exhaust components have been made from cast iron or steel. These materials work well in high temperature applications, but suffer drawbacks associated with long-term corrosion. The exhaust components of a typical motor vehicle operate in a highly corrosive environment and are prone to corrosion from both the outside and the inside. Exhaust components are typically mounted on the exterior of a motor vehicle, usually underneath the vehicle body and therefore have external surfaces that are exposed to water and salt spray from roadways treated with salt during the winter months. The internal surfaces of an exhaust component are exposed to exhaust gases, which in addition to water vapor, can include urea from a urea injector. The urea, which is used by emission control subsystems, creates a corrosive environment inside the exhaust component.

Today, vehicle manufacturers have different steel requirements for various exhaust components to help resist corrosion. The outside surface of exhaust components must pass salt spray testing. The inside surface of exhaust components must pass urea corrosion testing if the exhaust components are to be used in diesel engine applications. Some alternatives to cast iron and steel have been developed that use coatings or surface cladding to reduce corrosion. High cost alloys and stainless steels have also been developed that offer improved corrosion resistance to salt and urea. However, other cost effective alternatives with improved corrosion resistance are still needed.

### SUMMARY

This section provides a general summary of the disclosure, and is not a comprehensive disclosure of its full scope or all of its features.

In accordance with an aspect of the present disclosure, an exhaust component for a motor vehicle with improved corrosion resistance is provided. The exhaust component includes an internal volume, an inlet, and an outlet. The inlet is disposed in fluid communication with the internal volume and is configured to receive exhaust gas. The outlet is also disposed in fluid communication with the internal volume and is configured to expel exhaust gas. The exhaust component includes one or more walls. At least one of the walls of the exhaust component is made of a diffusion surface alloyed metal sheet. The diffusion surface alloyed metal sheet comprises a secondary metal that is formed to a primary metal substrate by diffusion. The primary metal substrate of the diffusion surface alloyed metal sheet is a stainless steel and has a primary metal chromium content of at least 10 percent chromium. The secondary metal of the diffusion surface alloyed metal sheet has a secondary metal chromium content that is greater than the primary metal chromium content and is within a range of 20 to 35 percent chromium. In accordance with this construction, the primary metal substrate itself is corrosion resistant. The secondary metal further enhances corrosion resistance to salt and/or urea without negatively impacting the formability (e.g., ductility) and strength of the diffusion surface alloyed metal sheet. In other words, the enhanced corrosion resistance provided by the high chromium in the secondary metal can be utilized without materially increasing the cost and/or the brittleness of the metal sheet. As a result, the diffusion surface alloyed metal sheet can be stamped, rolled, or bent during manufacture of the exhaust component without breaking or cracking despite the high chromium content of the secondary metal. In this regard, the diffusion surface alloyed metal sheet described herein provides advantages over metal sheets with a coating or surface cladding, which are prone to failure as a result of the coating or surface cladding becoming separated from the base metal substrate during stamping, rolling, or bending operations.

In accordance with another aspect of the present disclosure, the exhaust component further includes a housing with one or more outer walls that define the internal volume. The one or more outer walls have an inside surface facing the internal volume and an outside surface facing an external zone, which is positioned outside the housing. The exhaust component may further include one or more inner walls positioned in the internal volume of the housing that define an exhaust chamber within the internal volume. At least part of one of the outer walls or one of the inner walls is made of a diffusion surface alloyed metal sheet constructed in accordance with the description set forth above.

In accordance with yet another aspect of the present disclosure, at least part of the outer wall and at least part of the inner wall are made of one or more diffusion surface alloyed metal sheets. In accordance with this configuration, the secondary metal on each respective diffusion surface alloyed sheet can be selected to resist the different corrosive environments in the external zone versus the exhaust chamber. For example, the diffusion surface alloyed metal sheet forming at least part of the outer wall can include a core layer made of a primary metal substrate and one or more cover layers made of a secondary metal that is more corrosion resistant to salt than the primary metal substrate in the core layer. Similarly, the diffusion surface alloyed metal sheet forming at least part of the inner wall can include a core layer made of the primary metal substrate and one or more cover layers made of a secondary metal that is more corrosion resistant to urea than the primary metal substrate in the core layer.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is an enlarged, fragmentary cross-sectional view of a diffusion surface alloyed metal sheet constructed in accordance with the present disclosure;

FIG. 2a is a top perspective view of the diffusion surface alloyed metal sheet shown in FIG. 1 where the cover layer of secondary metal completely covers the core layer of primary metal substrate;

FIG. 2b is a top perspective view of another diffusion surface alloyed metal sheet where the cover layer of secondary metal only covers portions of the core layer of primary metal substrate;

FIG. 2c is a top perspective view of another diffusion surface alloyed metal sheet where the cover layer includes two different secondary metals that cover different portions of the core layer of primary metal substrate;

FIG. 3 is an exemplary exhaust component constructed in accordance with the present disclosure, where the exhaust component is constructed from the diffusion surface alloyed metal sheet shown in FIG. 1;

FIG. 4 is another exemplary exhaust component constructed in accordance with the present disclosure, where part of the exhaust component is constructed from the diffusion surface alloyed metal sheet shown in FIG. 1;

FIG. 5 is another exemplary exhaust component constructed in accordance with the present disclosure, where the exhaust component houses a diesel particulate filter (DPF) and part of the exhaust component is constructed from the diffusion surface alloyed metal sheet shown in FIG. 1;

FIG. 6 is another exemplary exhaust component constructed in accordance with the present disclosure, where the exhaust component houses a diesel oxidation catalyst (DOC) and part of the exhaust component is constructed from the diffusion surface alloyed metal sheet shown in FIG. 1;

FIG. 7 is another exemplary exhaust component constructed in accordance with the present disclosure, where the exhaust component houses a selective catalytic reduction (SCR) unit and part of the exhaust component is constructed from the diffusion surface alloyed metal sheet shown in FIG. 1; and

FIG. 8 is a bar graph illustrating corrosion test results of various samples of stainless steel sheets and the diffusion surface alloyed metal sheets described herein.

### DETAILED DESCRIPTION

Referring to the Figures, wherein like numerals indicate corresponding parts throughout the several views, various exhaust components 10, 110, 210, 310, 410 for motor vehicles are illustrated where at least part of each exemplary exhaust component is constructed from a diffusion surface alloyed metal sheet 20.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

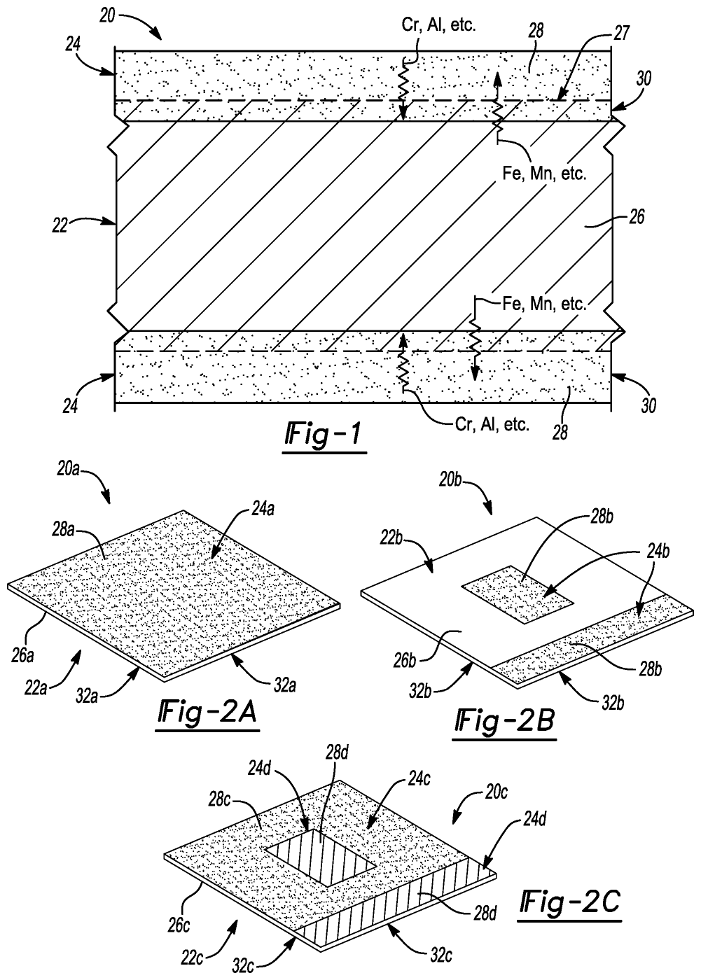

FIG. 1 is an enlarged cross-sectional view of a diffusion surface alloyed metal sheet 20. The diffusion surface alloyed metal sheet 20 in this illustration is comprised of a core layer 22 that is positioned between two cover layers 24. The core layer 22 is made of a primary metal substrate 26. The cover layers 24 at least partially cover the original substrate surface 27 of the primary metal substrate 26. The cover layers 24 are made of a secondary metal 28 and are formed by surface diffusion of chromium (Cr) into the metal substrate 26. The primary metal substrate 26 is a stainless steel having a primary metal chromium content of at least 10 percent. The stainless steel in the core layer 22 can be either ferritic stainless steel or austenitic stainless steel. It should be appreciated that the stainless steel forming the primary metal substrate 26 in the core layer 22 is different from carbon/low carbon steels, which have a chromium content that is well below 10 percent. The cover layers 24 are chromium rich alloy having an average chromium content that is greater than the primary metal chromium content and is within a range of 20 to 35 percent chromium. The diffusion surface alloyed metal sheet 20 includes two transition zones 30 positioned between the core layer 22 and the cover layers 24, which are formed by inward-diffusion of the supplied elements, e.g., chromium (Cr) and/or aluminum (Al), into the metal substrate 26 and outward-diffusion of the elements from the primary metal substrate 26, e.g., iron (Fe) and manganese (Mn). Within the transition zone 30 a molecular concentration of the secondary metal 28 gradually decreases and a molecular concentration of the primary metal substrate 26 gradually increases moving toward the core layer 22. As a result, there is a gradual change in the chemistry, and properties of the diffusion surface alloyed metal sheet 20 in the transition zones 30. It should be appreciated that the two cover layers 24 may be made of the same secondary metal 28 or alternatively the cover layer 24 on one side of the core layer 22 may be made of a first secondary metal 28 while the cover layer 24 on the opposing side of the core layer 22 is made of a second secondary metal 28 that is different than the first secondary metal 28. It should also be appreciated that diffusion surface alloyed metal sheet 20 could alternatively include one cover layer 24 on just one side of the core layer 22.

There are a variety of manufacturing processes that can be used to form the diffusion surface alloyed metal sheet 20. In one exemplary process for creating metallurgically bonded metal, the chromium in the secondary metal 28 is applied in a slurry system to a sheet of the primary metal substrate 26. The sheet of the primary metal substrate 26 with the slurry is then rolled up and heated (baked) using an oven or other heating equipment. The combination of the slurry configuration, controlled atmosphere, and heat leads to formation of the secondary metal 28.

It should be appreciated that diffusion surface alloyed metal sheets 20 are different from hot dip coated or cladded metal sheets. Hot dip coated or cladded metal sheets include an outer layer that remains mostly as supplied and the bond between the base metal substrate and the outer layer is highly localized. As a result, the molecular concentration of the outer layer material and the base metal substrate change abruptly at the boundary between the outer layer material and the base metal substrate. There is no transition zone where the, chemistry, and properties of the metal sheet change gradually between the layers. This is also the reason why metal sheets with a coating or surface cladding are prone to failure as a result of the coating or surface cladding becoming separated from the base metal substrate during stamping, rolling, or bending operations. For example, surface cladding often cracks and/or separates from the base metal substrate during spinning operations that are commonly used in the industry to add a flange or reduced diameter portion to a tubular exhaust component.

The secondary metal 28 in the diffusion surface alloyed metal sheet 20 described herein has a higher chromium content than the stainless steel forming the primary metal substrate 26 such that the secondary metal 28 is more corrosion resistant to salt and urea than the stainless steel forming the primary metal substrate 26. To use diffusion surface alloyed metal sheets 20 in exhaust components, the diffusion surface alloyed metal sheets 20 may undergo one or more stamping, rolling, or bending operations during the manufacturing process. High chromium content steels are typically harder, more brittle, and more expensive than lower chromium content steels. This translates to higher cost components that are more difficult to stamp, roll, or bend during manufacturing. The diffusion surface alloyed metal sheet 20 described herein utilizes the enhanced corrosion resistance of the chromium rich secondary metal 28 without the associated drawbacks of poor formability and high cost because a large percentage of the diffusion surface alloyed metal sheet 20 is made up of the primary metal substrate 26, which is a stainless steel with a lower chromium content than the secondary metal 28. In addition, the microstructure and shape of the grains of the secondary metal 28 in the cover layers 24 can be tailored for improved formability and durability.

It should be appreciated that various configurations of diffusion surface alloyed metal sheets are possible. For example, FIG. 2a illustrates a diffusion surface alloyed metal sheet 20a that includes a single cover layer 24a of secondary metal 28a that completely covers one face of the core layer 22a of primary metal substrate 26a. In other words, the cover layer 24a of secondary metal 28a covers 100 percent of the surface area of one side of the core layer 22a of primary metal substrate 26a.

FIG. 2b illustrates a different configuration of a diffusion surface alloyed metal sheet 20b, which includes a partial cover layer 24b of secondary metal 28b that covers only a portion of one face of the core layer 22b of primary metal substrate 26b. In other words, the cover layer 24b of secondary metal 28b covers less than 100 percent of the surface area of one side of the core layer 22b of primary metal substrate 26b. In accordance with this embodiment, the cover layer 24b of secondary metal 28b may be applied to only those portions (i.e., areas) of the diffusion surface alloyed metal sheet 20b that are left exposed to the external environment (salt spray and water) or exhaust gases (water vapor and urea). In each of these configurations, the cover layers 24a, 24b of secondary metal 28a, 28b do not extend over the edges 32a, 32b of the diffusion surface alloyed metal sheets 20a, 20b.

FIG. 2c illustrates another configuration of a diffusion surface alloyed metal sheet 20c, which includes a first cover layer 24c containing a first secondary metal 28c that covers only a portion of one face of the core layer 22c of primary metal substrate 26c. The diffusion surface alloyed metal sheet 20c also includes a second cover layer 24d containing a second secondary metal 28d that covers a different portion of one face of the core layer 22c of primary metal substrate 26c. Together, the first and second cover layers 24c, 24d may or may not cover 100 percent of the surface area of one side of the core layer 22c of primary metal substrate 26c. In accordance with this embodiment, the secondary metals 28c, 28d in the first and second cover layers 24c, 24d are different and have different percentages of chromium content. The secondary metal 28c having a lower chromium content and therefore better formability may be applied to portions (i.e., areas of the diffusion surface alloyed metal sheet 20c that are designed to be bent, rolled, or stamped. The secondary metal 28d having a higher chromium content and therefore more corrosion resistance may be applied to only those portions (i.e., areas) of the diffusion surface alloyed metal sheet 20c that are left exposed to the external environment (salt spray and water) or exhaust gases (water vapor and urea). Accordingly, a diffusion surface alloyed metal sheet 20c with custom tailored outer surfaces can be created. It should be appreciated that as another option, the first cover layer 24c may cover 100 percent of the surface area of one side of the core layer 22c of primary metal substrate 26c and the second cover layer 24d may be applied on top of the first cover layer 24c.

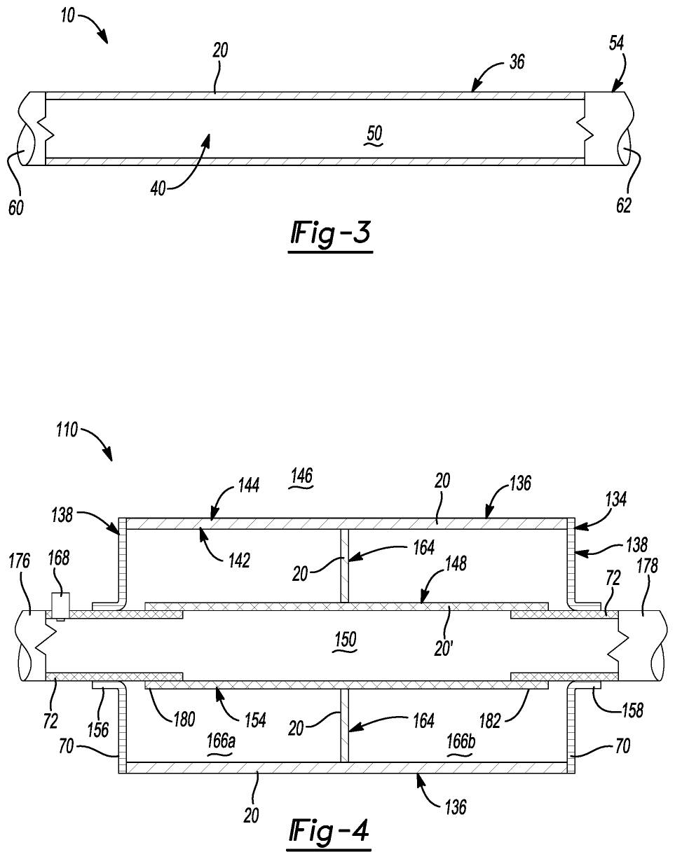

The exhaust component 10 shown in FIG. 3 is a typical exhaust pipe. The exhaust component 10 includes an internal volume 40, an inlet 60, and an outlet 62. The inlet 60 is disposed in fluid communication with the internal volume 40 and is configured to receive exhaust gas. The outlet 62 is also disposed in fluid communication with the internal volume 40 and is configured to expel exhaust gas. The exhaust component 10 includes an outer wall 36. The outer wall 36 is provided in the form of a tube 54 and is made of the diffusion surface alloyed metal sheet 20 described above in connection with FIG. 1. The tube 54 defines an exhaust chamber 50 therein that extends between the inlet 60 and the outlet 62. Although the tube 54 may be manufactured in numerous ways, in one non-limiting example, a diffusion surface alloyed metal sheet 20 can be rolled into tube 54 and welded at the seam.

The exhaust component 110 shown in FIG. 4 includes a housing 134 with an outer wall 136 and two end walls 138 that cooperate to define an internal volume 140 of the housing 134. The outer wall 136 has an inside surface 142 facing the internal volume 140 of the housing 134 and an outside surface 144 facing an external zone 146 that is positioned outside the housing 134. The exhaust component 110 further includes an inlet conduit 176 that extends into a flanged inlet opening 156 in the housing 134 and an outlet conduit 178 that extends into a flanged outlet opening 158 in the housing 134. The exhaust component 110 includes an inner wall 148 in the form of a tube 154 that extends between the inlet conduit 176 and the outlet conduit 178. The tube 154 defines the exhaust chamber 150 therein and the inlet conduit 176 and the outlet conduit 178 are arranged in fluid communication with the exhaust chamber 150. The tube 154 includes an inlet end 180 that receives part of the inlet conduit 176 in an overlapping relationship and an outlet end 182 that receives part of the outlet conduit 178 in an overlapping relationship. As a result, the inlet end 180 of the tube 154 extends annularly about and supports an outer circumference of the inlet conduit 176. Similarly, the outlet end 182 of the tube 154 extends annularly about and supports an outer circumference of the outlet conduit 178.

A urea injector 168 is placed in the inlet conduit 176. The urea injector 168 is configured to inject urea (e.g., liquid NH₃ or gaseous NH₃) into the flow of exhaust gases passing through the tube 154. This urea is utilized in an emission control process for the treatment of diesel engine exhaust that takes place in a selective catalytic reduction (SCR) unit. Optionally, one or more partitions 164 may be installed in the internal volume 140 of the housing 134. The partitions 164 divide the internal volume 140 of the housing 134 into one or more chambers 166a, 166b and can help support the tube 154 within the housing 134.

Although other configurations are possible, the end walls 138 of the housing 134 are made of a salt resistant metal 70 such as 409 stainless steel and the inlet and outlet conduits 176, 178 are made of a urea and salt resistant metal 72 such as 309 austenitic stainless steel or 439 stainless steel. The outer wall 136 of the housing 134 and the partitions 164 are made of diffusion surface alloyed metal sheets 20. In addition to these walls, the inner wall 148 in FIG. 4 is also made from a diffusion surface alloyed metal sheet 20′. For example, a diffusion surface alloyed metal sheet 20′ can be rolled into tube 154. The secondary metal 28 in the diffusion surface alloyed metal sheet 20 forming the outer wall 136 and partitions 164 is selected to be more corrosion resistant to salt than the primary metal substrate 26 in the core layer 22. The secondary metal 28 in the diffusion surface alloyed metal sheet 20′ forming the inner wall 148 is selected to be more corrosion resistant to urea than the primary metal substrate 26 in the core layer 22. In other words, the secondary metal 28 used in the diffusion surface alloyed metal sheets 20 for the outer wall 136 and the partitions 164 can be selected particularly for its corrosion resistance to salt while the secondary metal 28 used in the diffusion surface alloyed metal sheets 20′ for the inner wall 148 can be selected particularly for its corrosion resistance to urea. The result is an exhaust component 110 with walls 136, 148, 164 made of diffusion surface alloyed metal sheets 20, 20′ that are tailored to the different corrosive environments in the external zone 146 outside the housing 134 and the exhaust chamber 150 inside the housing 134.

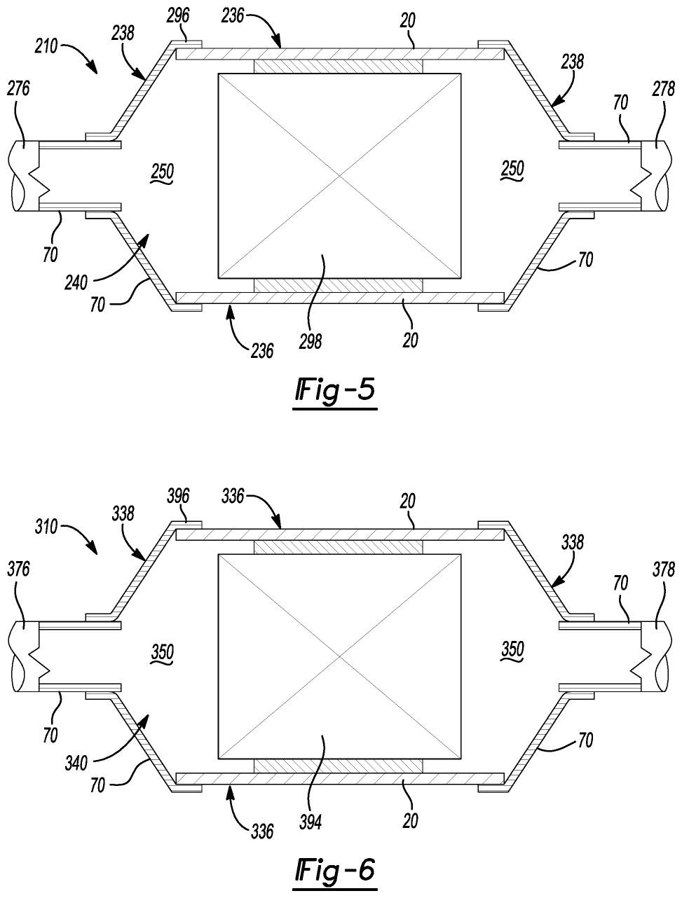

FIG. 5 illustrates an alternative configuration for an exhaust component 210 where the tube 154 and partitions 164 in the exhaust component 110 shown in FIG. 4 are replaced with a diesel particulate filter 298 (DPF). The other features of the exhaust component 210 shown in FIG. 5 are the same as those described above in connection with the exhaust component 110 shown in FIG. 4, except as noted below. The exhaust component 210 shown in FIG. 5 includes end walls 238 that have a frusto-conical (i.e., funnel) shape and the exhaust chamber 250 occupies the entire internal volume 240 of the housing 234. The diesel particulate filter 298 is positioned and supported within the internal volume 240 of the housing 234. Flanges 296 extend from the end walls 238 over an outer wall 236 of the housing 234. The end walls 238, the inlet conduit 276, and the outlet conduit 278 are made of a salt resistant metal 70 while the outer wall 236 of the housing 234 is made of the diffusion surface alloyed metal sheet 20 described above in connection with FIG. 1.

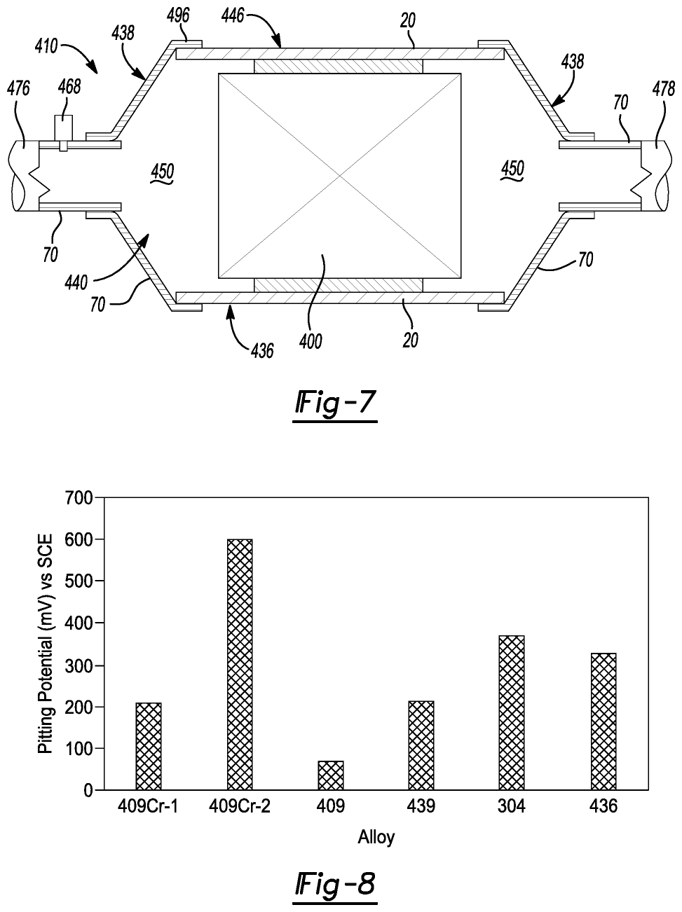

FIG. 6 illustrates an alternative configuration for an exhaust component 310 where the diesel particulate filter 298 shown in FIG. 5 is replaced with a diesel oxidation catalyst 394 (DOC). The other features of the exhaust component 310 shown in FIG. 6 are the same as those described above in connection with the exhaust component 210 shown in FIG. 5. FIG. 7 illustrates an alternative configuration for an exhaust component 410 where the diesel particulate filter 298 shown in FIG. 5 is replaced with a selective catalytic reduction (SCR) unit 400. A urea injector 468 is also installed in the inlet conduit 476 to inject urea into the exhaust gas flowing through the exhaust chamber 450. This urea is consumed by the selective catalytic reduction (SCR) unit 400 as part of an emissions control process that converts nitrogen oxide (NOx) emissions into nitrogen, water, and a small amount of carbon dioxide (CO2). The other features of the exhaust component 410 shown in FIG. 7 are the same as those described above in connection with the exhaust components 210 shown in FIG. 5.

FIG. 8 is a bar graph illustrating corrosion test results for four different samples of stainless steel sheets and two different samples of the diffusion surface alloyed metal sheet 20 described herein. The data shown in FIG. 8 was collected using cyclic potentiodynamic measurements conducted according to ASTM G61, a published procedure which is expressly incorporated herein by reference. A silver/silver-chloride (Ag/AgCl) electrode was used as a reference electrode. The horizontal or x-axis of the graph lists the 6 different samples that were tested, where: 409Cr-1 represents a first sample of the diffusion surface alloyed metal sheet 20 described herein wherein the core layer 22 was made of 409 stainless steel and the cover layers 24 were made of a chromium-rich alloy having a higher chromium content than the chromium content of the 409 stainless steel; 409Cr-2 represents a second sample of the diffusion surface alloyed metal sheet 20 described herein wherein the core layer 22 was made of 409 stainless steel and the cover layers 24 were made of a chromium-rich alloy having a higher chromium content than the chromium content of the cover layers 24 in sample 409Cr-2; 409 represents a sample of 409 stainless steel; 439 represents a sample of 439 stainless steel; 304 represents a sample of 304 stainless steel, and 436 represents a sample of 436 stainless steel. Pitting potential is listed on the vertical or y-axis of the graph in millivolts (mv) and is measured versus a saturated calomel electrode (SCE). In general, the higher the pitting potential is, the more resistant the sample is to corrosion. In other words, higher pitting potential measurements represent better, more corrosion resistant samples.

As shown in FIG. 8, the cover layers 24 of the 409Cr-1 sample of the diffusion surface alloyed metal sheet 20 more than doubled the pitting potential over the 409 stainless steel sample and offered comparable corrosion resistance to more expensive 439 stainless steel. The cover layers 24 of the 409Cr-2 sample of the diffusion surface alloyed metal sheet 20, which had an even higher chromium content relative to the first sample, raised the pitting potential and therefore the corrosion resistance to well above that of the other stainless steel samples tested. This data shows that higher percentages of chromium in the secondary metal 28 used for the cover layers 24 results in higher pitting potentials and improved corrosion resistance. This correlation must be balanced against the formability drawbacks associated with higher chromium percentages. The data shown in FIG. 8 demonstrates that the diffusion surface alloyed metal sheet 20 disclosed herein can achieve comparable or superior corrosion resistance to expensive stainless steel alloys, including 439 stainless steel, 304 stainless steel, and 436 stainless steel.

Many other modifications and variations of the present disclosure are possible in light of the above teachings and may be practiced otherwise than as specifically described while within the scope of the appended claims.

What is claimed is:

1. An exhaust component for a motor vehicle, comprising:
an internal volume;
an inlet disposed in fluid communication with said internal volume for receiving exhaust gases;
an outlet disposed in fluid communication with said internal volume for expelling exhaust gases; and
at least one wall made of a diffusion surface alloyed metal sheet comprising a secondary metal that is formed to a primary metal substrate by diffusion,
wherein said primary metal substrate is stainless steel and has a primary metal chromium content of at least 10 percent chromium and said secondary metal has a secondary metal chromium content that is greater than said primary metal chromium content and is within a range of 20 to 35 percent chromium.

2. The exhaust component set forth in claim 1, wherein said diffusion surface alloyed metal sheet includes a core layer made of said primary metal substrate and at least one cover layer made of said secondary metal.

3. The exhaust component set forth in claim 2, wherein said diffusion surface alloyed metal sheet includes at least one transition zone between said core layer and said at least one cover layer where a molecular concentration of said secondary metal gradually decreases and a molecular concentration of said primary metal substrate gradually increases moving toward said core layer.

4. The exhaust component set forth in claim 2, wherein said diffusion surface alloyed metal sheet includes at least one transition zone between said core layer and said at least one cover layer where a molecular concentration of chromium gradually decreases moving toward said core layer.

5. The exhaust component set forth in claim 2, wherein said at least one cover layer extends across and completely covers one face of said diffusion surface alloyed metal sheet.

6. The exhaust component set forth in claim 2, wherein said at least one cover layer extends across only a portion of one face of said diffusion surface alloyed metal sheet such that said primary metal substrate is exposed across other portions of said face of said diffusion surface alloyed metal sheet.

7. The exhaust component set forth in claim 2, wherein said at least one cover layer includes a first portion made of a first secondary metal and a second portion made of a second secondary metal that is different from said first secondary metal.

8. The exhaust component set forth in claim 2, wherein said at least one wall made of said diffusion surface alloyed metal sheet is positioned inside said inner volume and wherein said secondary metal in said at least one cover layer is more corrosion resistant to urea than said primary metal substrate in said core layer.

9. The exhaust component set forth in claim 2, wherein said at least one wall made of said diffusion surface alloyed metal sheet forms an outer wall that includes an inside surface facing said internal volume and an outside surface facing an external zone and wherein said secondary metal in said at least one cover layer is more corrosion resistant to salt than said primary metal substrate in said core layer.

10. The exhaust component set forth in claim 1, wherein said inner volume is defined by a housing having an outer wall that separates said inner volume from an external zone.

11. The exhaust component set forth in claim 9, wherein said at least one wall made of said diffusion surface alloyed metal sheet is a tube, positioned within said inner volume of said housing, that extends between said inlet and said outlet and defines an exhaust chamber therein.

12. The exhaust component set forth in claim 9, wherein said at least one wall made of said diffusion surface alloyed metal sheet is a partition disposed inside said housing that divides said inner volume into multiple chambers.

13. The exhaust component set forth in claim 1, wherein said diffusion surface alloyed metal sheet includes a core layer made of said primary metal substrate that is positioned between two cover layers made of said secondary metal.

14. The exhaust component set forth in claim 12, wherein said diffusion surface alloyed metal sheet includes transition zones between said core layer and said cover layers where a molecular concentration of said secondary metal gradually decreases and a molecular concentration of said primary metal substrate gradually increases moving toward said core layer.

15. The exhaust component set forth in claim 1, further comprising:
at least one of a diesel oxidation catalyst or a selective catalytic reduction (SCR) unit positioned within said internal volume.

16. The exhaust component set forth in claim 1, further comprising:
a diesel particulate filter (DPF) positioned within said internal volume.

17. An exhaust component for a motor vehicle, comprising:
a housing including at least one outer wall defining an internal volume of said housing;
said at least one outer wall having an inside surface facing said internal volume of said housing and an outside surface facing an external zone positioned outside of said housing;
at least one inner wall positioned in said internal volume of said housing that defines an exhaust chamber within said internal volume; and
at least part of one of said outer or inner walls being made of a diffusion surface alloyed metal sheet comprising a secondary metal that is formed to a primary metal substrate by diffusion,
wherein said primary metal substrate is stainless steel and has a primary metal chromium content of at least 10 percent chromium and said secondary metal has a secondary metal chromium content that is greater than said primary metal chromium content.

18. An exhaust component for a motor vehicle, comprising:
a housing including at least one outer wall defining an internal volume of said housing;
said at least one outer wall having an inside surface facing said internal volume of said housing and an outside surface facing an external zone positioned outside of said housing;
at least one inner wall positioned in said internal volume of said housing that defines an exhaust chamber within said internal volume; and
at least part of said outer wall and at least part of said inner wall being made of one or more diffusion surface alloyed metal sheets each comprising a secondary metal that is formed to a primary metal substrate by diffusion.

19. The exhaust component set forth in claim 18, wherein said secondary metal in said diffusion surface alloyed metal sheet forming at least part of said outer wall is more corrosion resistant to salt than said primary metal substrate.

20. The exhaust component set forth in claim 19, wherein said secondary metal in said diffusion surface alloyed metal sheet forming at least part of said inner wall is more corrosion resistant to urea than said primary metal substrate.
